(19) United States
(12) Patent Application Publication
(10) Pub. No.: US 2014/0289166 A1
(43) Pub. Date: Sep. 25, 2014

(54) INVESTMENT SCORING AND MANAGEMENT SYSTEM AND METHOD

(71) Applicant: sKKore, LLC, Annapolis, MD (US)

(72) Inventor: Peter S. WYROUGH, Edgewater, MD (US)

(21) Appl. No.: 14/218,539

(22) Filed: Mar. 18, 2014

Related U.S. Application Data
(60) Provisional application No. 61/792,499, filed on Mar. 15, 2013.

(51) Int. Cl. G06Q 40/06

(52) U.S. Cl. CPC G06Q 40/06
USPC 705/36 R

(57) ABSTRACT

A method of real time assessment of an aggregated investment portfolio requiring a computer coupled to a database of statistical financial data includes querying the database and retrieving a set of data points associated with a plurality of investments; controlling the processor to sort like-kind investments of the plurality of investments into an investment type and storing the plurality of investments in a system database; receiving via an electronic user interface data associated with at least one user investment; querying the system database via the processor to match each of the at least one user investment with the set of data for one of the plurality of investments; deriving an investment score for each of the at least one user investment using the processor to compare and rank the set of data points for each user investment against all the sets of data points for the plurality of other like-kind investments.

### CROSS-REFERENCE TO RELATED APPLICATIONS

This application claims priority to U.S. Provisional Patent Application No. 61/792,499, entitled, “INVESTMENT SCORING AND MANAGEMENT SYSTEM AND METHOD,” filed Mar. 15, 2013, which is hereby incorporated by reference in its entirety.

### FIELD OF THE INVENTION

The disclosure generally relates to investment portfolio analysis, asset allocation and, more particularly, to an algorithmic approach for evaluation and scoring of the overall and sectored performance of an individual's investment portfolio while providing easy and efficient access via methods and systems to the scoring results and tiered performance data for making informed decisions based on the results.

### BACKGROUND OF THE INVENTION

A disconnect exists between the rate of return on an investment and the investor. The investment rate of return is typically internalized by the investor and compared subconsciously to the rate of return they get on their savings account. If the investor's investment generates a rate of return several percentage points above what they are getting on their savings, they may be perfectly content with the investment regardless of whether or not it is a good rate of return. Investors have no easy or understandable way to quantify their investment rate of returns.

Today, investors are confronted with literally thousands of investment options making it extremely difficult to invest. There are over 17,000 mutual funds alone. To further complicate investment decisions, economic conditions ebb and flow like the weather. These changes may significantly impact the overall performance of your investment portfolio. It is therefore important to be able to track what happens to your investments during all economic environments. In many cases, investors do not really know what or how to think about managing and maximizing their investment returns. Many investors, in fact, spend more time researching their favorite sports team then they do analyzing their investments.

The world is becoming a smaller place and with the onset of the internet, information overload can make investing complicated. Further, investors often have multiple accounts within different financial institutions (i.e., individual accounts, joint accounts, bank accounts, 529 accounts, IRAs, Roth IRAs, 401(k)s, simple IRAs, thrift savings accounts, fixed annuities, variables annuities, etc.). As a result, portfolio management problems ensue with the typical behavior of the investor.

During various times of the year, statements for each type of account are either mailed or delivered electronically. The first thing most investors typically do upon receipt of their statements is subconsciously drop their eyes down to the bottom line to see what the account is worth. The previous month's value is often reported as well and a quick comparison indicates if the new balance is higher or lower than the previous balance. A higher balance tends to make us feel good inside. Most investors typically will put the statement down and go about their lives. A lower balance may entice some to look further into the statement to determine what is causing the statement to go lower. Because people are creatures of habit, the same process may be repeated multiple times every month for each separate account statement received.

These habits often lead to another potential problem. As a result of so many statements, investors end up managing accounts individually. Investors often have no idea how one account may affect another account. Is there too much of one investment class and not enough of another? The investment process is much like cooking. In order to get the right outcome, investors need to have the right balance of ingredients. Too much or too little of any one ingredient might spoil the end result. Not only is the balance of ingredients important to the outcome, so is the quality of the ingredients.

In a world with more time constraints than ever before for the investor and the advisor, investing has become more challenging due to the vast amounts of data available, including how the data is catalogued, processed and displayed. It does not have to be this way. The system and methods disclosed herein help with all of these issues and many more. On the smallest, but possibly most important level, meaning is given to the rate of return for a particular investment over any period of rolling time. The investment's rate of return over a specific period of time may be compared to all other investments within the investment's peer group during those same time periods.

For example, in 2013, an investor might have had a large cap value mutual fund that returned 15% for the year. By most counts, the majority of investors would be very happy with that rate of return. A question all investors should ask themselves is: how does the rate of return over a particular period of time score on a scale against all other like kind investments from the universe of all investments during that same time period? If the answer is 25, for example, the investor may now know that, while 15% sounds like a good number, 75% of the peers within the classroom of large cap value did better than 15%. Would the investor still be happy?

The opposite can also be true. Let's say for the same hypothetical 2013 year you own an investment that is down −8% for the year. Most people would not be happy. However, it depends. By giving meaning to the rate of return by scoring the investment against its peers for the same time period, the investor now knows where that investment truly stands. For example, the system and methods disclosed herein may show that the investment, although down for the year, ranks in the 95 percentile in its investment class of peers. The score indicates that the investment performed better than 94% of all the other investments inside its peer group classroom over that time period. The investor is probably happier knowing their investment was actually one of the top 5% best performing investments inside its peer group classroom over that time period.

The voluminous amount of data for processing and analyzing, as well as the complexity as to the true meaning of that data to any one investor, requires a system and methods that aggregates and analyzes the data in ways never before done to give meaning to your investments individually and as aggregate investment groupings to eventually include an overall portfolio score. A real-time, final score at various levels of granularity may be provided every time to provide context to the performance of your portfolio overall as well as right down to each investment individually. Like a credit score that helps you identify your credit worthiness, the methods and systems disclosed herein provide the user with an investment score that helps them understand the strengths and weaknesses of their investments and the results for which it reflects on the health of their overall portfolio.

Investment opportunities may generally be divided into two categories, fixed and variable investments. Fixed investments typically involve loaning money to a person, government entity, or company, for example, for a fixed period of time for a fixed rate of return. Fixed asset types include cash, United States treasuries, corporate bonds, inflation protected bonds, municipal state bonds, preferred stock, foreign bonds, the cash value of life insurance, stable value funds, money markets, high-yield bonds, personal loans, Certificates of Deposit (CD), Collateralized Mortgage Obligations (CMO), Quasi-Government Agency paper, and senior loans. Mutual funds, Unit Investment Trusts (UIT), and closed-end funds, all of which invest in fixed assets, may be included as well.

Variable investments involve taking ownerships positions in an entity where the rate of return on investment can vary. Because variable investments are generally more volatile than their fixed counterparts, variable investments are the hardest to manage. Variable asset types may include, without limitation, common stock, real estate, commodities, collectibles, convertibles, currency, mutual funds, closed-end funds, and exchange-traded funds (ETFs) that use variable asset types to make investments.

A third category may also be defined, which includes investment types that allocate investing between all investment classes, both fixed and variable. These hybrid investments may include investment types such as, for example, allocation funds or age-based funds. Ultimately, the methods and systems disclosed herein provide an investor a better understanding of the relationship between the two macro categories of investments, Lender (fixed) vs. Owner (variable) investments.

Individual investors typically have a mixed portfolio of fixed and variable investments. These investments may be individually managed and/or grouped together into investment accounts. It takes an enormous amount of time, expertise and effort to manually assess an investment or portfolio against the universe of available information to determine how that investment or portfolio stacks up against the world of possible investments. Moreover, any such assessment is germane to a specific point in time, and the effort must be continuously repeated if prompt investment decisions are not made and/or to re-evaluation of investment or portfolio performance is required due to changing markets, changing investment performance, and/or changes in an investor's investment tolerance profile, for example.

Individual investors have come to rely on large Wall Street investment firms and armies of investment advisors to both provide and sort through the reams of data necessary to make informed decisions regarding the performance of investments and the potential of investment opportunities. Unfortunately, the very people in control of providing this investment information, those from whom investment advice is solicited, often have clear conflicts of interest. For example, investment recommendations may be made today that are based on how a particular advisor gets compensated rather than what is in the best interest of the individual investor.

An individual investor needs tools and methods that are able to sort through the complexities of investing to present in real time a simple, consolidated and informative picture of their investments, individually and in aggregate. The individual investor must be provided a way to immediately visualize how well their investments are performing in aggregate while also having the ability to parse such top-level information into detailed qualitative information on the performance of individual investments or classes of investments. The data must be presented in a way that gives the investor real time feedback and flags on investments that are under performing, while providing the investor opportunities to make real time adjustments that may be based on an investment's relative performance while taking into consideration an investor's tolerance for risk, for example, or their desire to achieve a particular balance of asset allocations.

The systems and methods of the present invention provide direct insight for an investor into the very important questions of how well investments are performing against all other investments within the same category of investments and how consistent that performance may be over different periods of time. While prior performance is no guarantee of future performance, historical performance data over different periods of time and market cycles may be used to aid in identifying strengths and weaknesses of the investment and investment portfolio. Further the investor is provided tools to easily aggregate an entire portfolio of investments in order to view the asset allocation of all investments and compare that to industry standard allocations with the goal of achieving a proper investment balance. A clear visualization of an investor's entire portfolio performance is provided, giving an investor the tools necessary to make informed investment decisions while simultaneously making Wall Street firms and investment managers more accountable with respect to how their investment strategies are performing

### SUMMARY OF THE DISCLOSURE

The foregoing needs are met by the present disclosure, wherein according to certain aspects, an investment scoring and management system uses mapping templates and weighted ranking algorithms to assess the performance of an investment portfolio and the individual investments comprising the portfolio.

The system may be a user-friendly visualization, aggregation, reporting, and scoring tool that identifies the strengths and weaknesses of a user's investment portfolio relative to asset allocation and continuous scoring of investments over rolling periods of time. The system may map a user's investments and their respective values to a classroom of like investments and groupings to derive a mapping allocation analysis. The invention may compare each investment to its peers within its investment type within a classroom to derive an individual investment ranking score for each investment. The user may have the flexibility to generate their own investment score based on the user selecting their own percentage weightings for the performance scores of the different measurements of periods of time for each rolling rate of return of the investment. A default setting may be included with the tool in the event the user does not select to enter their own rolling rate of return weighting values. The tool may then calculate the combined scores of each investment based on groupings of like kind investment peers using weighted average scoring with the dollar value of the investment combined with the investment and investment groupings scores. This results in financial performance scores for each like kind grouping of investments and ultimately the users total investment portfolio. These scores are reported to the user, stored by the system, and then used to provide a historical charting of performance for the scores of the individual user's investments as well as the classrooms and investment groupings included in the overall portfolio.

The system may provide the user the ability to invite another individual or financial advisor to view their investment portfolio and its respective scores. In addition, the system may allow the user to rate their financial advisor. One of the features of the system may be the ability for users to view all of the advisors within a specified distance of the user based on their GPS location. This will allow the user to invite participating advisors within their area and view the advisors credentials and customer reviews by other users.

In accordance with yet other aspects of the present disclosure, a color coded flagging system may be established supporting email or texting notification capabilities that will notify the user when their investment triggers any preset strength or weakness parameters based on the tool's scoring and allocation system. In accordance with yet other aspects of the present disclosure, an email notification could be generated according to user preferences that would notify the user and/or the user's advisor of any flags. In accordance with yet other aspects of the present disclosure, a version of the tool may be specifically tailored to aid companies with retirement plans whereby the user and the company will be able to use this tool to better manage their retirement plan.

In accordance with another aspect of the present disclosure, a financial data module may deliver financial data from a financial data source for categorization into like kind investment groupings and classrooms. A performance score may be determined for particular investments within investment types inside the classrooms and each individual performance score may then be processed through a financial algorithm to arrive at a classroom score. Each classroom may then be similarly combined using weighted averages to arrive at a total score for fixed and variable assets, which in turn may be combined using a weighted averaging procedure to derive an overall portfolio score.

There has thus been outlined, rather broadly, certain aspects of the present disclosure in order that the detailed description herein may be better understood, and in order that the present contribution to the art may be better appreciated.

In this respect, before explaining at least one embodiment of the invention in detail, it is to be understood that the invention is not limited in its application to the details of the construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a view of a display illustrating an account access page for an investment management and scoring system, in accordance with aspects of the present disclosure;

FIG. 2 is a view of a display illustrating an account creation page for an investment management and scoring system, in accordance with aspects of the present disclosure;

FIG. 3 is a view of a display illustrating a home page for an investment management and scoring system, in accordance with aspects of the present disclosure;

FIG. 4 is a view of a display illustrating a data entry page for an investment management and scoring system, in accordance with aspects of the present disclosure;

FIG. 5 is a view of a display illustrating aspects of a graphical user interface for an investment management and scoring system, in accordance with aspects of the present disclosure;

FIG. 6 is a view of a display illustrating additional aspects of a graphical user interface for an investment management and scoring system, in accordance with aspects of the present disclosure;

FIG. 7 is a chart illustrating a list of exemplary financial data points, in accordance with aspects of the present disclosure;

FIG. 8 is a view of a display illustrating a portfolio score, in accordance with aspects of the present disclosure;

FIG. 9 is a view of a display illustrating a classroom score and asset allocation, in accordance with aspects of the present disclosure;

FIG. 10 is a view of a display illustrating a reports page, in accordance with aspects of the present disclosure;

FIG. 11 is a view of a mapping process template, in accordance with aspects of the present disclosure;

FIG. 12 is a view of another mapping process template, in accordance with aspects of the present disclosure;

FIG. 13 is a legend for asset category abbreviations, in accordance with aspects of the present disclosure;

FIG. 14 illustrates and account summary mapping process template, in accordance with aspects of the present disclosure;

FIG. 15 illustrates a mapping summary template, in accordance with aspects of the present disclosure;

FIG. 16 illustrates a fixed assets mapping template, in accordance with aspects of the present disclosure;

FIG. 17 illustrates a mapping process template for recommended balances and percentages for fixed assets, in accordance with aspects of the present disclosure;

FIG. 18 illustrates a variable assets mapping template, in accordance with aspects of the present disclosure;

FIG. 19 a mapping process template for recommended balances and percentages for variable assets, in accordance with aspects of the present disclosure;

FIG. 20 illustrates a high-level block diagram of various system components, in accordance with aspects of the present disclosure

FIG. 21 is a flow diagram illustrating an exemplary method of assessing an aggregated investment portfolio in accordance with aspects of the present disclosure;

FIG. 22 the detailed steps involved in processing and sorting the imported raw financial data, in accordance with aspects of the present disclosure;

FIG. 23 is a flow diagram illustrating a method of scoring the user input investments, in accordance with aspects of the present disclosure;

FIG. 24 is a flow diagram illustrating a method of computing user investment, classroom, category and total portfolio scores, in accordance with aspects of the present disclosure; and

FIGS. 25-31 illustrate various aspects in which derived scores may be electronically displayed, in accordance with aspects of the present disclosure.

### DETAILED DESCRIPTION

Embodiments in accordance with the invention will now be described with reference to the drawing figures, in which like reference numerals refer to like parts throughout.

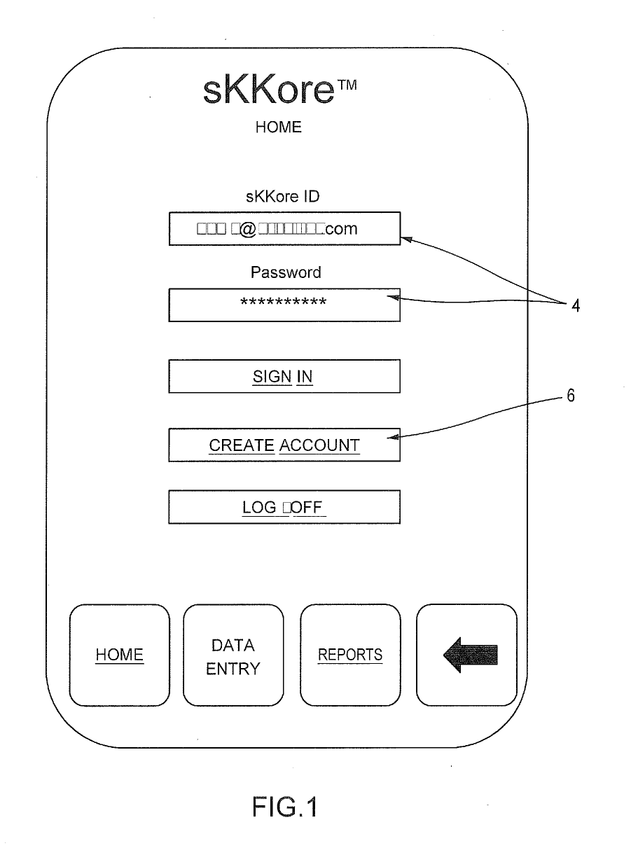

In accordance with aspects of the present invention, an investment scoring and management system, which may sometimes be referred to herein as sKKore™, may include a software application that executes on portable or stationary computers, a mobile phone or smartphone, a personal digital assistant, or a tablet device. FIG. 1 shows a screenshot of an exemplary landing page produced on a display in accordance with aspects of the present invention. The landing page may be the first page users see upon activation of the software application. Exemplary aspects of the invention as described herein may be referred to in conjunction with the trademark sKKore™.

The landing page, for example, may contain a login area 4 for those users with established accounts to enter a user identification (“ID”) and password. There may be application links 6 for new users to create an account. Other information on the landing page may include, for example, links to downloadable mobile applications for use with the system, and links to various pages, such as terms of use, privacy policies, security assurance, frequently asked questions, and/or retail/promotional partner information.

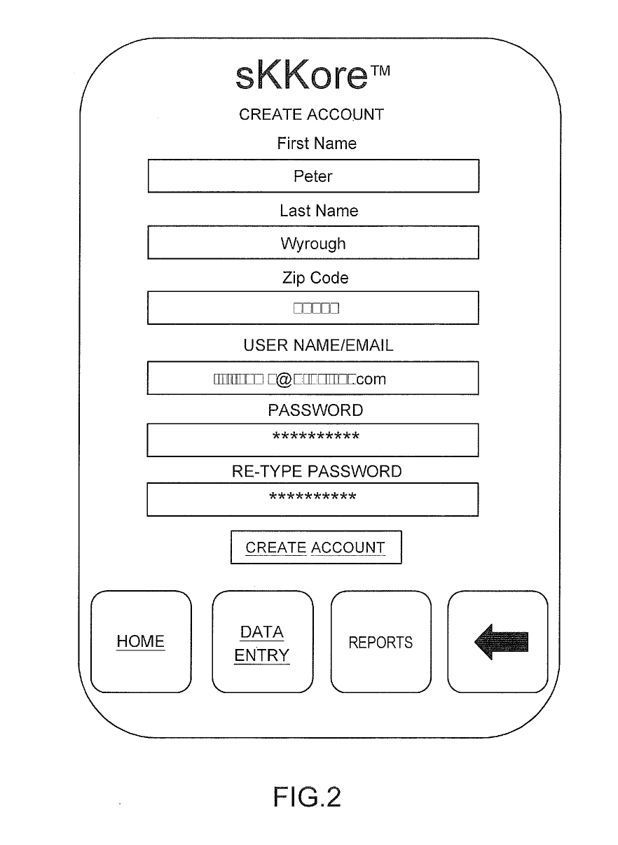

FIG. 2 illustrates an exemplary account creation module and related features, in accordance with aspects of the present invention. When a user decides to create an account, the user may be presented with a page with options for creating an account. An application wizard may be activated to aid the user in filling in a request form that asks for a variety of information. For example, establishing an account may involve providing name, address, and a user ID and password combination. In accordance with other aspects of the present invention, additional information may be requested in order to establish secure connections to financial institution database servers, for example, information such as date of birth, social security number, full address, email address, guardian's name (if under 18). A registration process may include reading and consenting to an electronic disclosure, and accepting the terms and conditions for creating an account on or through the sKKore™ system.

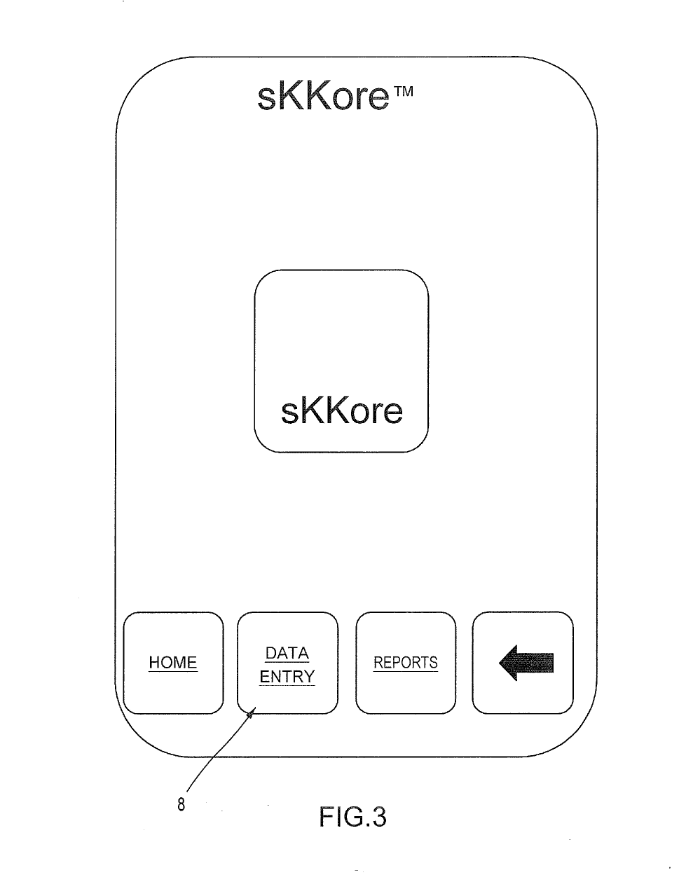

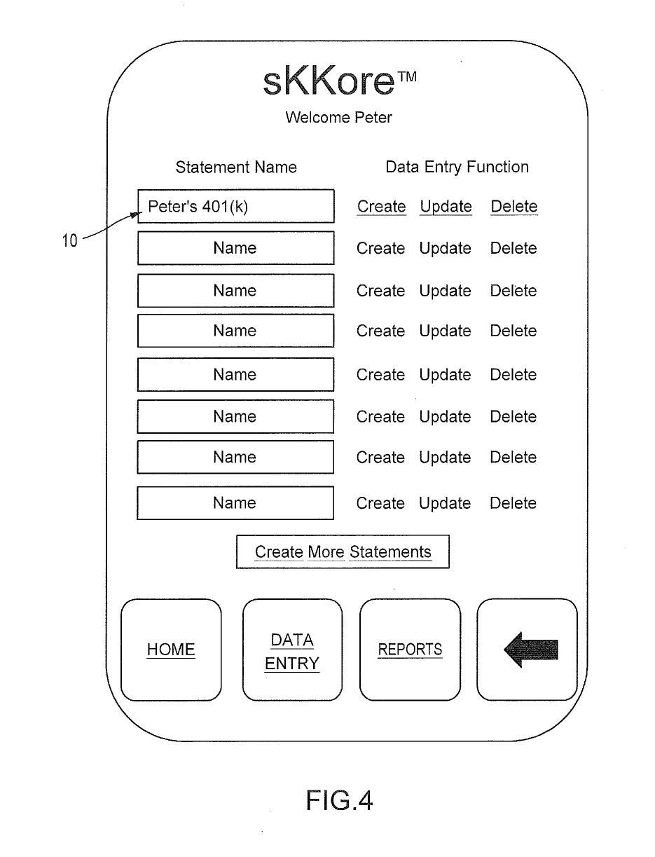

FIG. 3 illustrates an exemplary Home page accessible to investors having successfully established an account. The Home page may include a number of tabs for accessing different functions of the application. For example, a Data Entry tab 8 may be provided that takes a user to the Data Entry page illustrated in FIG. 4. The Data Entry page may include options for creating, updating and/or deleting an account entry 10. The system aggregates all of the account entries of an investor either by the investor manually entering their investment information for each account or via an application interface with the investor's financial institution. For example, account data may be requested and stored in a user input database established to seamlessly communicate and control the transfer of information between a financial institution's private labeled web server and the system. Data transferred to or from the financial institution may be subjected to a pre-defined secure data encryption process. A seamless integration of the sKKore™ system and the financial institution's system may enable an approved user to access their user account at the financial institution so investment data may be downloaded and updated at select times for use in the system. With communication established between the sKKore™ system and a financial institution, when an investor accesses their account on the system, for example, the backend authentication of the financial institution login and verification may occur automatically.

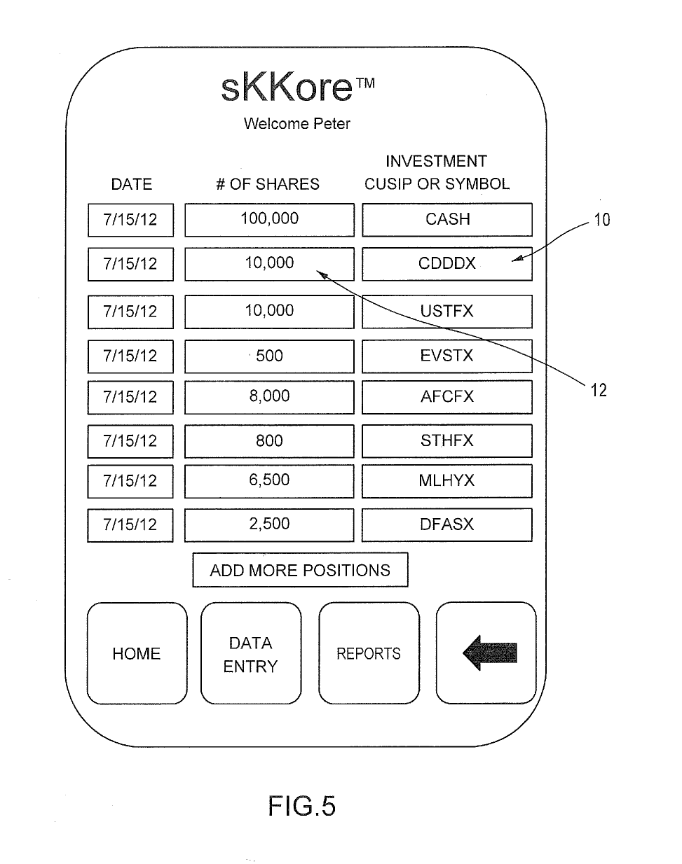

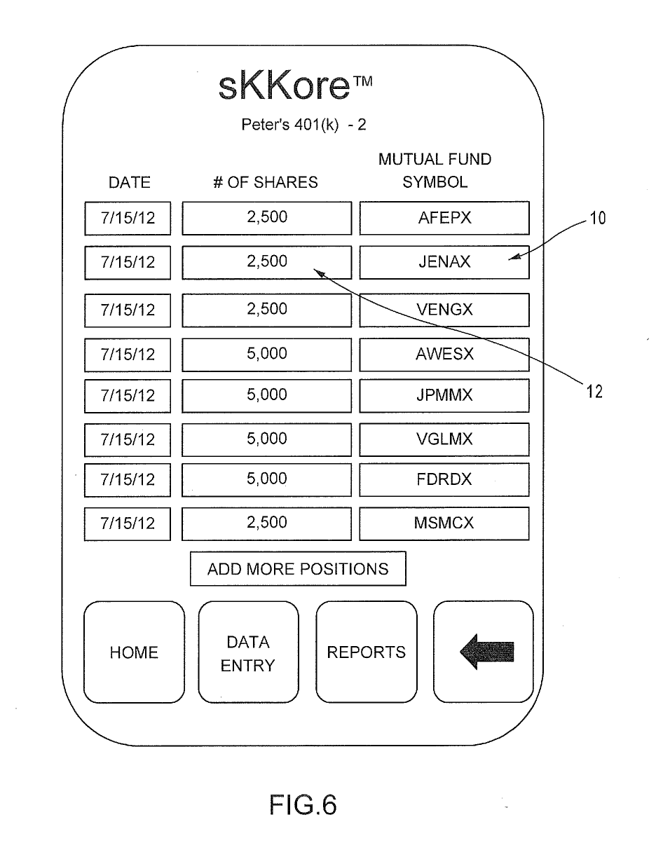

As shown in FIGS. 5 and 6, each investment may be associated with an investment account and has an investment cusip or symbol 10 and a number of shares or bonds 12. The system uses the cusip or symbol 10 to look up from a live market supplied data base the performance data related to the investment. In accordance with aspects of the present disclosure, a financial data delivery module may be used to retrieve, store, and/or distribute the relevant financial data. The financial data delivery module may include a server and a client. The server may be software on any type of computer capable of providing the financial performance data related to the investment, preferably in a compressed format. The server may be a virtual server or a cloud-based server executing on one or more computers. A software routine that is part of the software application executing on the device may be used to display the information to the investor.

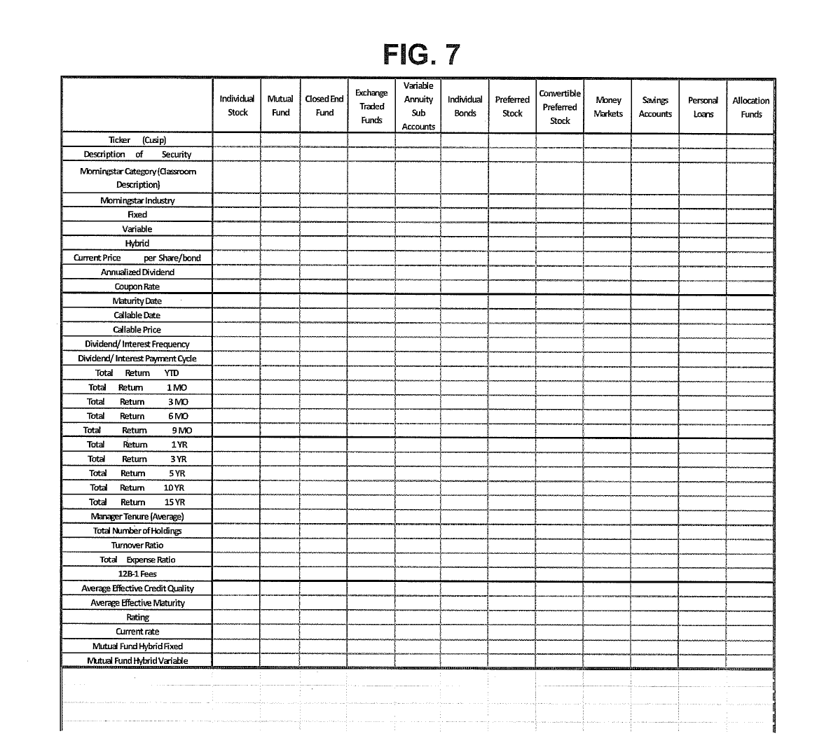

The financial data server may be coupled through a communication network, for example, to a source of financial data, such as Standard and Poor's (S&P), Reuters or barchart.com, for obtaining financial data related to the cusip or symbol. FIG. 7 is a chart illustrating a list of exemplary financial data points for each of the various investment types. The financial data may be imported and stored in a database server on the financial data server or the database server may be housed separately from the financial data server. The data may be updated at predetermined intervals, such as every 5 or 10 minutes, or daily, for example, depending on the time sensitivity of the data required for the algorithms carried out by the sKKore™ system. In accordance with aspects of the present invention, the financial data may be processed, compressed and stored on a distribution server for distribution to the sKKore™ application. The components of the financial data delivery module may be interconnected by communications interfaces, including a modem, a network interface (such as an Ethernet card), a communications port, wireless transmitter and receiver, Bluetooth, Wi-Fi, infra-red, cellular, satellite, a Personal Computer Memory Card International Association (PCMCIA) slot and card, etc.

Determining Scores

The sKKore™ system takes an investor's entire investment portfolio and through an algorithm scoring process ranks each investment against all other investments in their investment type within their own specific classroom. Classrooms are used by the sKKore™ system to allocate investments into similar asset categories. For example, a fixed asset investment may be classified based on the ability of the individual, corporation, state or government to meet their loan obligation, which includes the payment of interest and the repayment of the loan at maturity. The system obtains from the downloaded data points the rankings of an investment's perceived ability to repay its loans. For example, AAA is the best, AA-A is good, BBB or less is taking on more risk in the ability for the borrower to return the principal to the investor. In addition, each fixed asset investment may be further classified according to the terms for which the loan is made as being cash, short-term<1-5 years, 5-10 years, and 10 years and over. In addition, the fixed asset may be classified according to whether it is a core or non-core fixed asset. Core fixed investments include most domestic fixed investments. Non-core fixed investment include fixed investments from foreign countries and other sector related fixed investments like personal loans, preferred stock and convertible bonds.

With respect to variable investments, the sKKore™ system visualizes the investments as ownership investments that include non-core investments (sector, international, real estate, commodities, hedge funds, among others) and core investments (large, medium and small size mostly domestic companies). Each variable asset core investment may further be classified into three category types, value investments (which typically pay a dividend), growth investments (which retain earnings for growth and do not pay dividends), and blend investments (which is a combination of both value and growth investments).

Every investment in the investor's portfolio may thus be categorized by the sKKore™ system into a classroom. Each data point for a particular investment is then compared to each data point of all other investments similarly categorized in the same investment type within their classroom. The investment is essentially ranked against all peers for all or a subset of all of the data points identified in FIG. 7. If, for example, the particular investment is 1 of 100 peer investment vehicles in a particular classroom, and if the particular investment ranked number 100 in all categories, then the investment would get a base score of 100 out of 100. Vice versa, if the investment scored last in every data point comparison, the investment would get a base score of 1. The base score is thus the percentage ranking of the investment within its investment type within its classroom of peers of investments for a given rolling investment holding time period. While the default setting for the score range will be based on a scale of 100 to 1, with 100 being the best and 1 being the worst, the user will have the option under settings to flip that scale to 1 to 100 where 1 is the best and 100 is the worst.

The scoring/ranking algorithm of any given investment class may be set with default weighting, wherein certain scores/rankings of the investment's specific rolling rate of return time periods are valued over others. Thus, after the weighting is applied against the investment's various rate of return for the time periods, comparatively high scores/rankings (i.e., being near number 100 on a scale of 1 to 100) for a rolling rate of return time period given a relatively low weight may not bode as well for the score/ranking of an investment if it had scored comparatively high for a rolling rate of return time period given a relatively high weight. For example, for a particular classroom, a particular investor may value the total return on an investment over the last 3 months as being more important than the total return on that investment over the last 3 years. Through advanced settings in the system, the investor can thus give preferential weighting to one or more base scores, resulting in a user customized defined base weighted score.

The investment's performance data is then combined through the adjustable default weighted average of each performance data element to arrive at an overall ranking of the particular investment against all other like kind investments in the same investment type within the classroom.

A score for a particular investment in each investment type may be determined by the system as indicated above. The real time value of the investment to the investment type, and hence to each successive level up to the portfolio, may be determined by the sKKore™ system. First the system multiplies the computed ranking base scores for each rolling time period of returns for the investment by either the default or user set weighting for those rolling time periods of return to result in an investment's single base weighted score as described above. Then the system computes the investment's current market value by multiplying the number of shares for the investment by the current market dollar value of each share that was acquired from the imported database of the current market data of the universe of all investments. The weighted fractional values of each investment's then computed current market value compared to that of the investment type overall may be determined. Each individual investment base weighted score previously determined may then be multiplied by the fractional value of the investment's previously derived market value to the investment type within the classroom and all of the scores summed to arrive at an investment type score within its classroom. Each investment type score previously determined may then be multiplied by the fractional value of the investment type's worth to the classroom and all of the scores summed to arrive at a classroom score. Each classroom may then be similarly combined using weighted averages to arrive at a total score for discretely core and non-core for both fixed and variable assets. All bank accounts and all other “cash” classified assets may then be combined by the sKKore™ system through weighted averages of performance to arrive at a total score for cash within fixed assets. Core, non-core and cash in the fixed assets group may then be averaged through weighted averaging to arrive at one score for fixed assets. The core and non-core scores in the variable assets group may be averaged through weighted averaging to arrive at one score for variable assets. Hybrid assets group may be averaged through weighted averaging to arrive at one score for hybrids assets. Ultimately the fixed, variable and hybrid asset groups may be combined through weighted averaging to arrive at a final score/ranking of an investor's total investment portfolio.

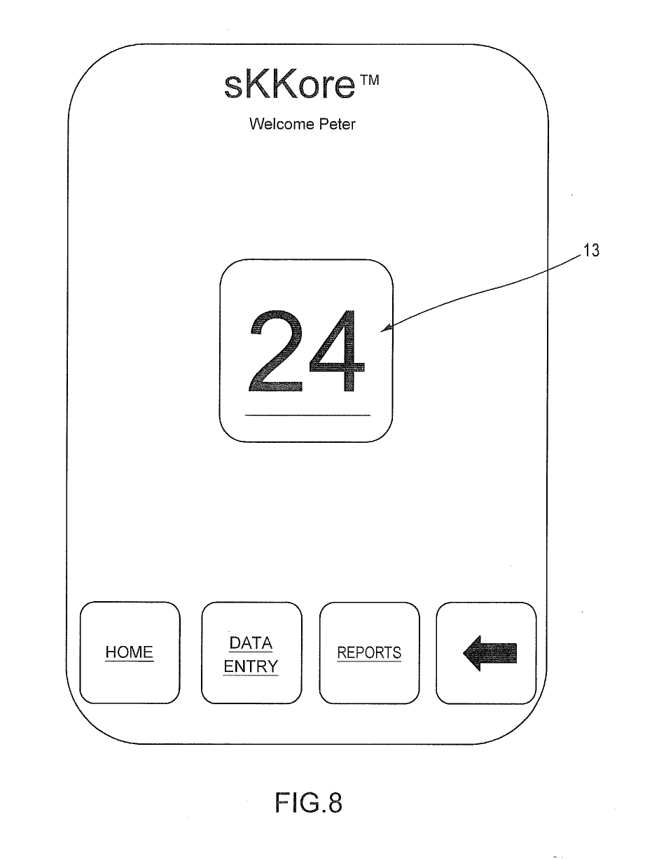

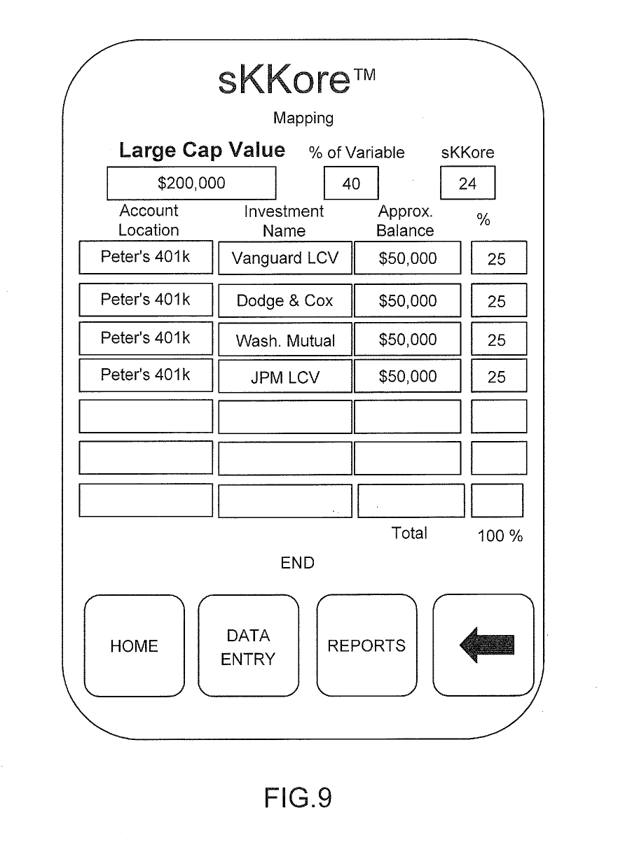

As shown in FIG. 8, on a smart phone, iPad, tablet PC, or computer, for example, the investor can quickly see the overall score 13 of their portfolio. In addition, as shown in FIG. 9, the investor may quickly drill down to find what areas of the portfolio that may be under performing, what improvements may be made, and what areas may be trending in a positive direction or contributing in some manner to the overall score. Thus, with a quick glance, an investor immediately garners real time status information on the overall performance of their investments through a single score with respect to the overall portfolio or a single score pertaining to each individual investment comprising the overall portfolio.

This invention gives meaning to an investment's rate of return and allows the user to keep watch over their investments. The invention gathers all the historical user's scores for all of the user's investments and scores for the user's financial groupings. These historical scores are then charted to track the score performance and changes for both the individual investments themselves as well as the financial scored groupings. On an on-going basis the user can track their performance as time passes and discover meaningful trends within his investments which may assist in making financial management decisions for the investments within the user's portfolio.

The sKKore™ system creates a very clear visualization of the user's entire portfolio picture which includes several heat maps of the investor's portfolio that uses a range of colors and sizes. For example, green may be used to indicate that the score is acceptable when compared to predetermined parameters set by the user, wherein yellow may indicate a potential problem or a negative trend, and red signals a serious underperforming asset. A heat map on scores verse money invested may be provided wherein the information on the tiles show the scores of the investments and the tile size shows the amount of money in the investment or investment class.

The sKKore™ system provides an on-going assessment of an investor's portfolio. The system users are able to visualize their entire portfolio through individual investment classroom rankings, collective investment weighted-average classroom rankings, universal collective portfolio investment weighted rankings and investment allocation within the universe of investment classrooms. Hence, strengths and weaknesses become more recognizable and the investment decision making process is made easier from a position of knowledge.

In accordance with certain aspects of the present invention, the sKKore™ system may even flag an individual investor as to specific investments in their portfolio that have fallen out of a set performance standard. Upon request, or established as a user setting tied to the investor's profile, for example, the system may suggest investments to replace the non-performing investment based on tracked performance standards and balancing algorithms. The investor may activate the trade and replacement of the non-performing asset with one of the selected highly ranked/performing suggested investments. In accordance with yet other aspects of the present disclosure, a list of investments scoring in the top quartile of all investments of a particular investment type, for example, may be generated and presented to the investor as a list of possible alternatives for any underperforming asset.

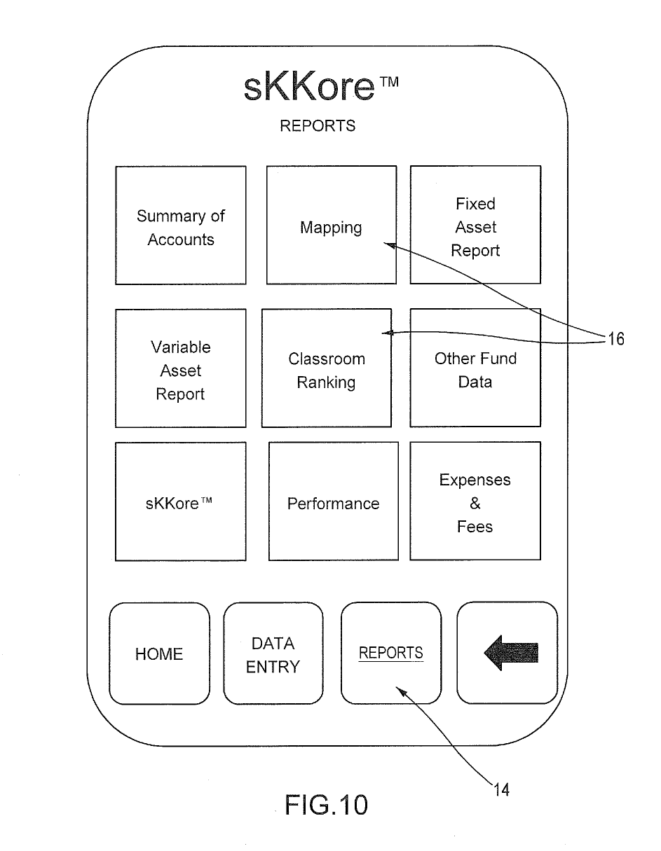

As shown in FIG. 10, a Reports Tab 14 may be provided for taking an investor to a Reports Page. The Reports Page may have various links for access to a variety of reports 16, such as a Summary of Accounts, Mapping, Fixed Asset Report, Variable Asset Report, Classroom Ranking, Performance, Expenses and Fees, among others. For example, one such report may provide the investor with an income report on all of their combined assets with a projection report listing the approximate income the user will earn from all investments, broken down by month, cycle and account location.

Mapping of Assets

Mapping or Mapping of Assets is an accounting of the investor's full portfolio of assets as aggregated by the system. The Mapping process performed by the system is designed to identify the strengths and weaknesses of an investor's investments with respect to asset allocation, personal objectives, and comparison's to peer group analysis.

Through the Mapping process, the system organizes the investor's aggregated portfolio of all investments, regardless of where the investments might be held, into different categories, or classrooms, for a concise assessment of the allocation of the portfolio. The Mapping process identifies the overall strengths and weaknesses of the investor's complete investment portfolio and plan, including, but not limited to the investor's stock and mutual funds portfolio, retirement accounts, 401K plans, thrift savings plans, 403(b), and IRAs. A real time snapshot of the investor's investments performance over time is obtained and each investment may be compared to recent and/or historic performance data of other investment options in the same category or classroom.

The Mapping process implemented by the system consists of establishing several templates which depict the investor's assets in a number of ways to aid in the investor's visualization of the allocation of the assets in his/her portfolio. The sKKore™ system first takes the investment identifier (the symbol or cusip) and the number of shares, bonds or interests the investor owns. The system uses the obtained financial data to multiply the number of shares owned to come up with an approximate current market value of the investment. The system then uses the investment identifier to determine the classroom that the investment belongs to and maps the value of that investment to the classroom in order to identify the collected total value of investments the user may have in each classroom. The system then totals the aggregate value of each classroom to obtain a total portfolio value for the portfolio. This bottom up valuation begins by taking the individual components from each account in the portfolio and classifying each investment to a classroom. The system then calculates the percentage representation that each classroom total represents relative to the total portfolio value at a given point in time.

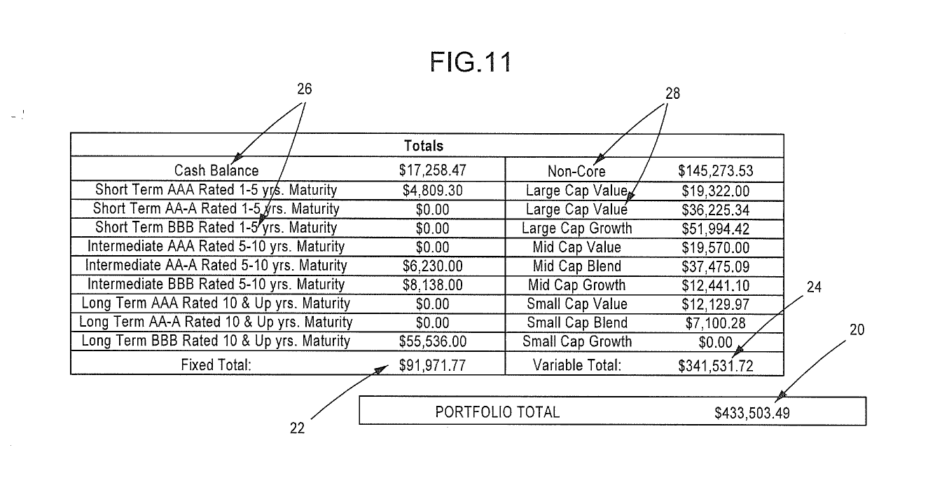

The mapping process provides a complete visualization of the portfolio value by breaking down the total portfolio value into two main components. As shown in FIG. 11, the total value 20 of the investor's portfolio may be determined by combining the total value of the funds/assets which are Fixed Assets 22 with those that are Variable Assets 24. The total Fixed Assets 22 is the sum of the funds/assets allocated to each of the fixed asset categories 26 and the total Variable Assets 24 is the sum of the funds/assets allocated to each of the variable asset categories 28.

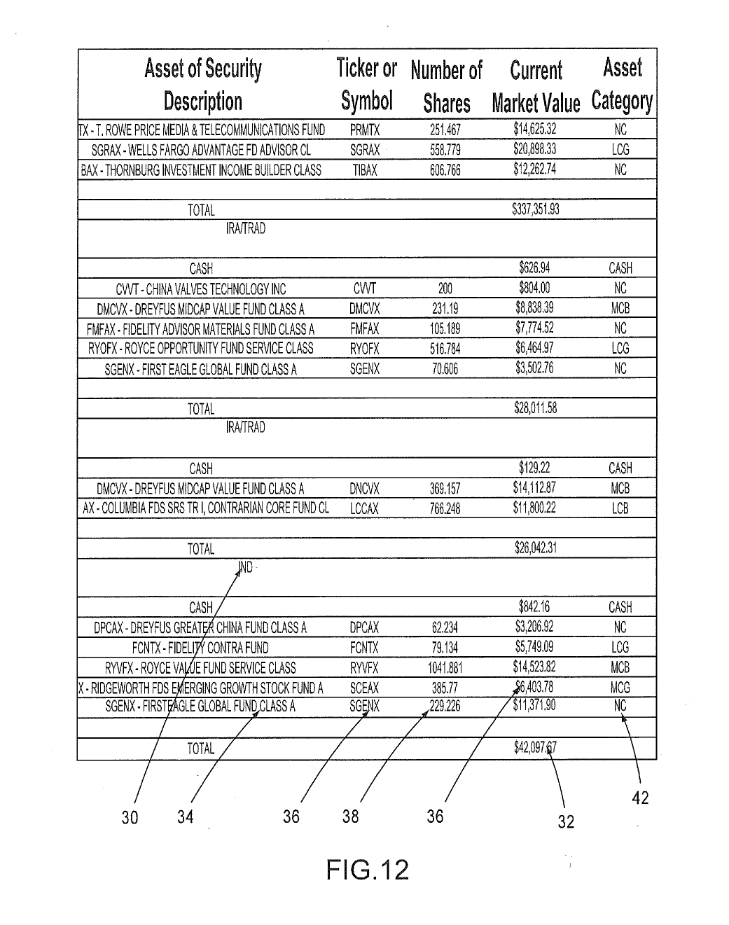

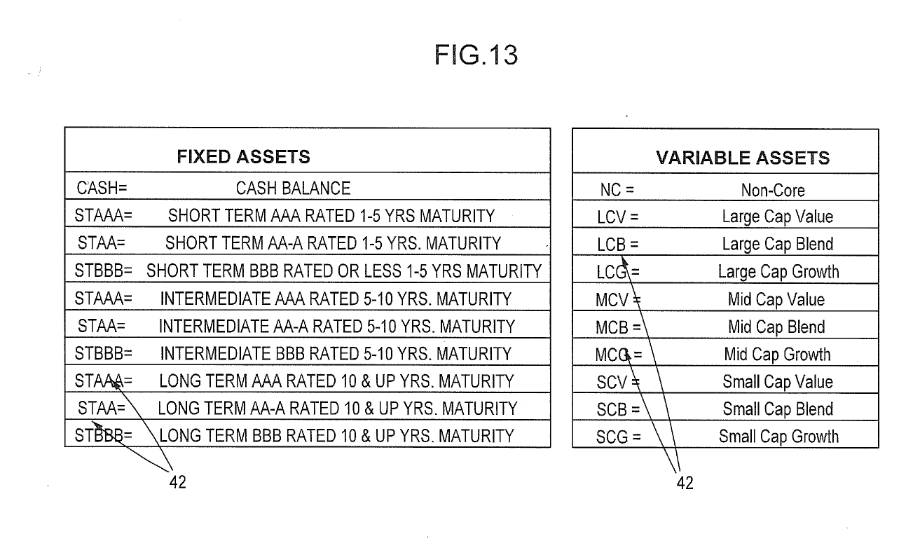

FIG. 12 shows that for each separate investment account name 30, a template may be established to determine the total value of the account 32, the specific fund(s) 34 which comprise the account, the ticker or symbol 36 of each fund in the Account, the number of shares 38 held in each fund in the account, and the current market value 40 of each fund in the account, as of the date and time the Mapping information was generated and received from the financial data delivery module, and, the asset category 42 of each fund in the account. FIG. 13 illustrates a legend for the asset category abbreviations 42 that may be used in the sKKore™ system in accordance with aspects of the present invention.

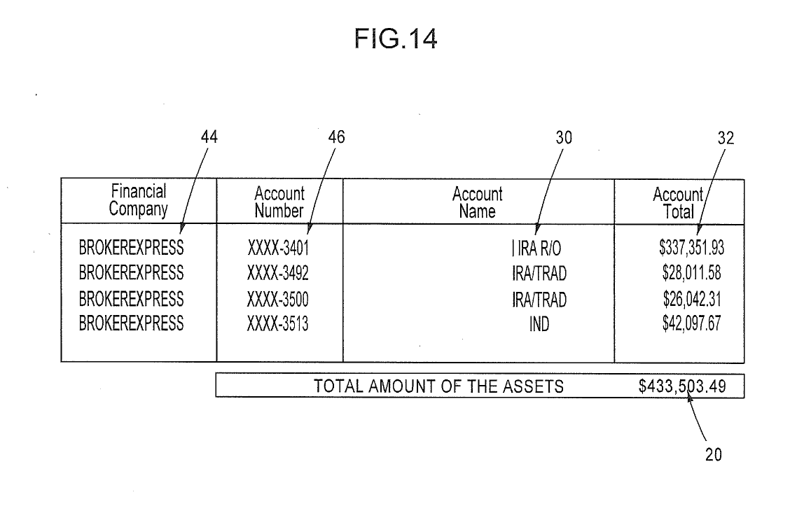

FIG. 14 illustrates an Account Summaries template in accordance with aspects of the present invention. The template may include the name of the financial company 44 holding the assets, the account number 46, and account name 30. Most investors have more than one account. The Mapping will reflect every account which the investor has.

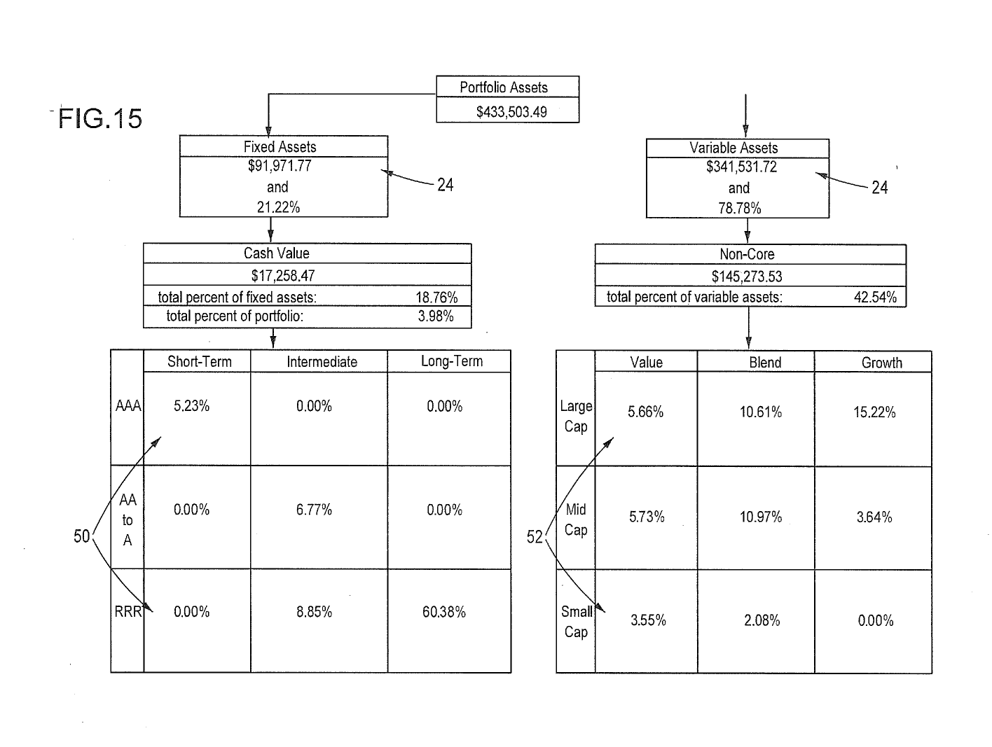

FIG. 15 illustrates a Mapping Summary template which shows the allocation of the assets in the total portfolio by Fixed Assets 22 and Variable Assets 24. For the purpose of illustration, FIG. 15 only shows templates for Core Fixed Assets and Core Variable Assets. However, each category of assets, i.e., Fixed Assets and Variable Assets, may have both Core Asset Classrooms and Non-Core Asset Classrooms. FIG. 15 illustrates that the Core Fixed Asset Classrooms 50 may consist of, for example, the following:
AAA—Short Term—<1-5 yrs maturity
AAA—Intermediate—5-10 years maturity
AAA—Long Term—10 years maturity
AA to A—Short Term—<1-5 yrs maturity
AA to A—Intermediate—5-10 yrs maturity
AA to A—Long Term—10 years and over maturity
BBB—Short Term <1-5 years maturity
BBB—Intermediate 5-10 years maturity
BBB—Long Term 10 years and over maturity
   and the Core Variable Asset Classrooms 52 may consist of, for example, the following:
Large Cap—Value
Large Cap—Blend
Large Cap—Growth
Mid-Cap—Value
Mid-Cap—Blend
Mid-Cap—Growth
Small Cap—Value
Small Cap—Blend
Small Cap—Growth
   As noted above, standard industry Non-Core Fixed and Non-Core Variable Asset Classroom templates would be generated by the system as well.

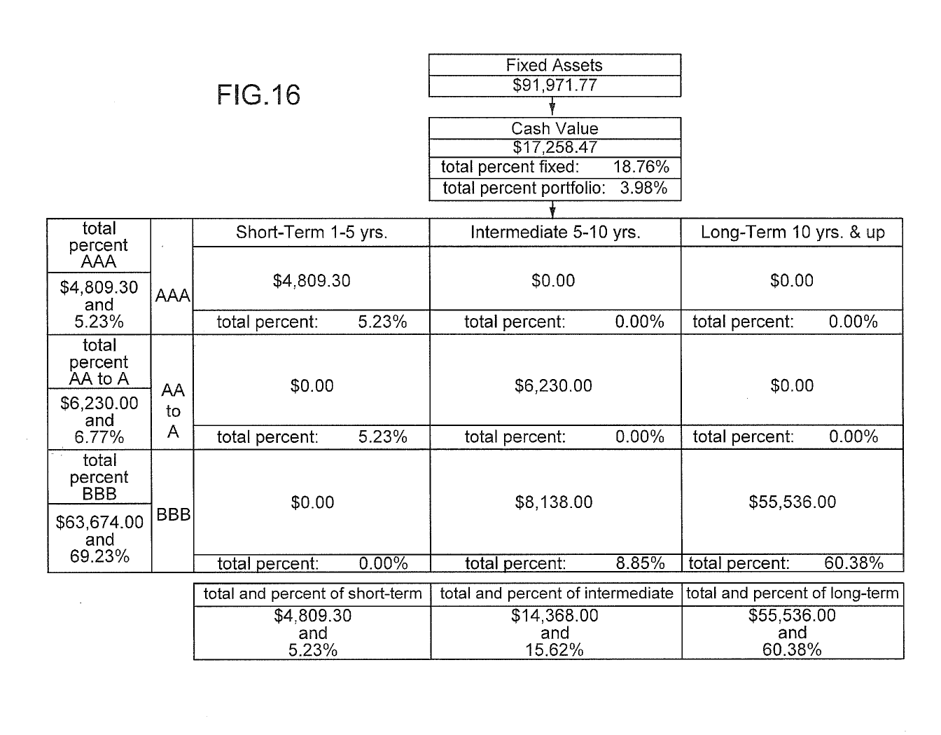

FIG. 16 illustrates a Mapping of the Fixed Assets in accordance with aspects of the present invention. The template shows the allocation of the Fixed Assets in the Portfolio by dollar amount and percentage of the Portfolio Fixed Assets, by both total Fixed Assets and by Classroom, dollar amount and percentage of the Fixed Assets in Short-Term investments, dollar amount and percentage of the Fixed Assets in Intermediate investments, and dollar amount and percentage of the Fixed Assets in Long-Term investments. The Fixed Asset Core Classrooms consist of:
AAA—Short Term <1-5 years
AAA—Intermediate 5-10 years
AAA—Long Term 10 years or more
AA to A—Short Term <1-5 years
AA to A—Intermediate 5-10 years
AA to A—Long Term 10 years or more
BBB—Short Term <1-5 years
BBB—Intermediate 5-10 years
BBB—Long Term 10 years or more
   A template comprising standard industry Non-Core Fixed Asset Classrooms would be generated by the system as well.

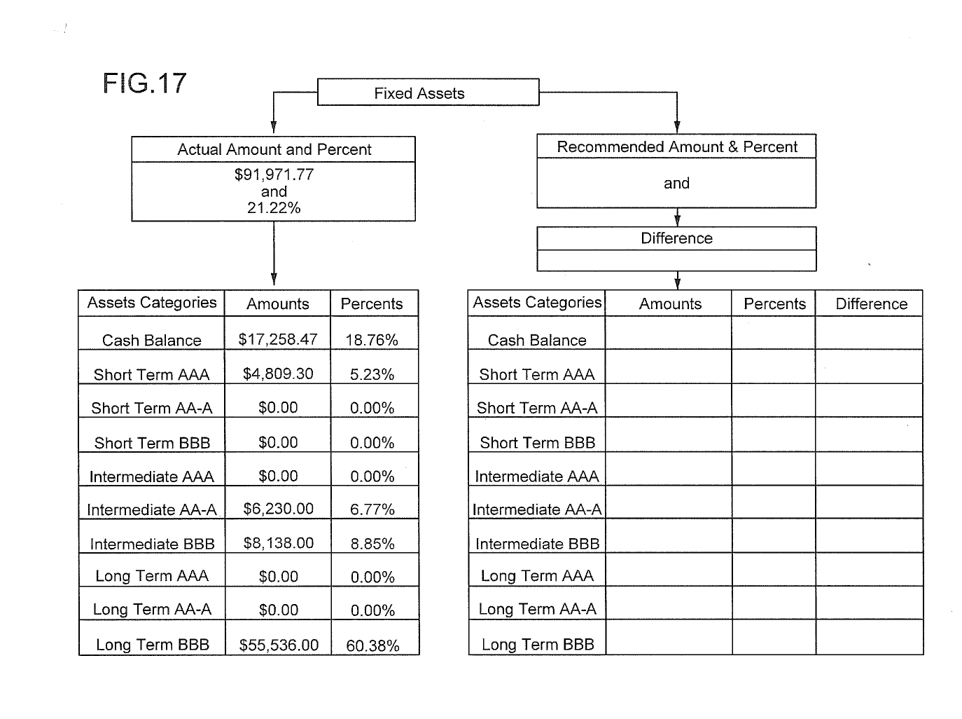

FIG. 17 illustrates a template created by the sKKore™ system for the Recommended Balances and Percentages for Fixed Assets. FIG. 17 shows the allocation of the Fixed Assets in the Portfolio by asset category, dollar amount and percentage of the total Fixed Assets. The left chart illustrates actual amounts and percentages. The right chart may rely on user input into the system for recommended amounts, at which time the system can calculate the difference. The recommended amounts may be input by the investor based on the investor's own research or desires, or the amounts may be generated by an investment advisor and input into the system. For example, the system may incorporate a feature that allows the investor to invite another user, such as their financial advisor, to be linked to the user's account. The system Financial Advisor (SFA) module, in accordance with other aspects of the present invention, may permit access by one or more advisors at one time and the access duration can be set by the investor. Upon the system determining a non performing investment has triggered an alert parameter, for example, the financial advisor may be flagged as well in order for them to be more proactive and responsive to their clients. The financial advisor may be better able to manage their client's portfolio, particularly in the case where the financial advisor may be seeing their client's total aggregated investments for the first time, thereby better serving their client's total financial picture.

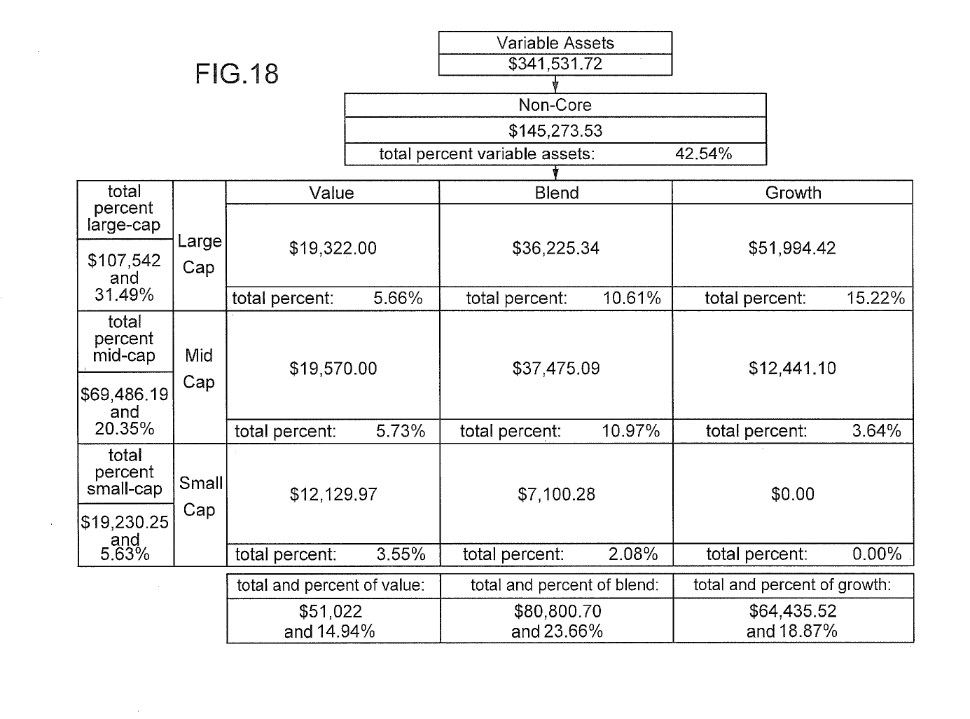

FIG. 18 illustrates the Mapping of the Variable Assets, which shows the allocation of the Variable Assets in the Portfolio by dollar amount and percentage of the Portfolio Variable Assets, by both total Variable Assets and by Classroom Dollar amount and percentage of the Variable Assets in Value investments, dollar amount and percentage of the Variable Assets in Blend investments, and dollar amount and percentage of the Variable Assets in Growth investments. The Core Variable Asset Classrooms consist of:
Large Cap—Value
Large Cap—Blend
Large Cap—Growth
Mid-Cap—Value
Mid-Cap—Blend
Mid-Cap—Growth
Small Cap—Value
Small Cap—Blend
Small Cap—Growth
   A template comprising standard industry Non-Core Variable Asset Classrooms would be generated by the system as well.

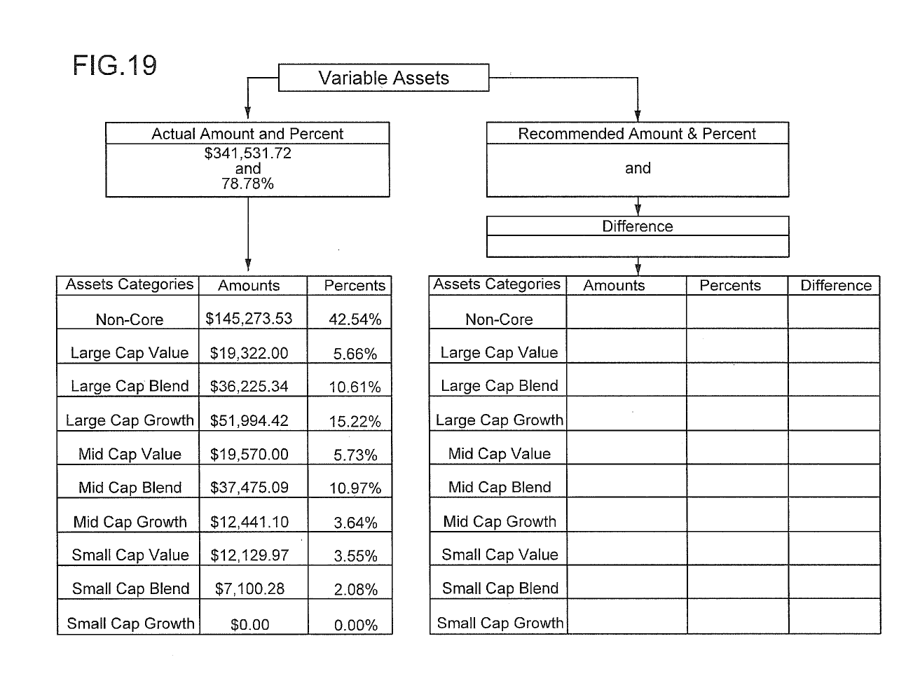

FIG. 19 illustrates a template created by the sKKore™ system for the Recommended Balances and Percentages for Variable Assets. FIG. 19 shows the allocation of the Variable Assets in the Portfolio by asset category, dollar amount and percentage of the total Variable Assets. The left chart illustrates actual amounts and percentages. The right chart may rely on user input into the system for recommended amounts, at which time the system can calculate the difference. The recommended amounts may be input by the investor based on the investor's own research or desires, or the amounts may be generated by an investment advisor and input into the system. As with the Fixed Assets, the sKKore™ Financial Advisor (SFA) module may be used to allow one or more advisors access to the investor's account in order to provide recommendations.

The sKKore™ system solves the problem of individuals not being able to easily aggregate all their investments in order to view the asset allocation of all of their investments and compare that to industry standard allocations to see where they may be out of balance. The invention visualizes the fixed investments relative to cash, core, non-core, credit quality and loan terms. The individual investor will immediately be able to see their classroom allocation values to determine allocations and over or under concentrations consistent with the user's goals and general market environment.

The sKKore™ system allows the user to apply preset investment allocation templates based on goals, age and risk tolerance which shows what the goal allocation within classrooms should be versus how the user currently has their investments allocated. The invention will provide dollars amount of change and reallocation of investments among the various classrooms. In addition, sKKore will show a before and after views of critical investment information to assist the user in identifying the changes that need to be made with in the classrooms to meet the recommended asset allocations. Further the invention may provide various investment choices within each classroom as suggestions for replacement or additions to a specific classroom.

The sKKore™ system can easily be tailored to suit the needs of anyone. For example, a version of the system directed to specifically corporate retirement plans may be configured to only provide the listing of investments available to the employees for investment. The system may also be configured to permit the invitation of one or more investment advisors to review the retirement assets of the investor.

Access to the software application and capabilities of the system in accordance with aspects of the present invention may occur via various hardware and access selection options. For example, a user may use locally loaded software, such as software provided on a personal computer (PC), minicomputer, microcomputer, mainframe computer, telephone device, hand-held device such as a personal digital assistant (PDA), or other wireless device with a processor, display, and capability for connecting to a network, such as the Internet.

Access to aspects of the present invention may be by way of a web server. The server may include, for example, a PC, minicomputer, microcomputer, mainframe computer, or other device having a processor and a repository for data. The server may be connected to a separate repository for data, which could be, for example, a secure database server for storing transactional data such as user account information, preferences, and security information. The server may be a host web server or a primary data server, and may be situated, for example, at a financial institution (such institution including a “bank”) or at any location permitting connectivity to the network as described herein. The server may be securely connected to a banking or financial management system that may separately include a bank server and a bank database repository.

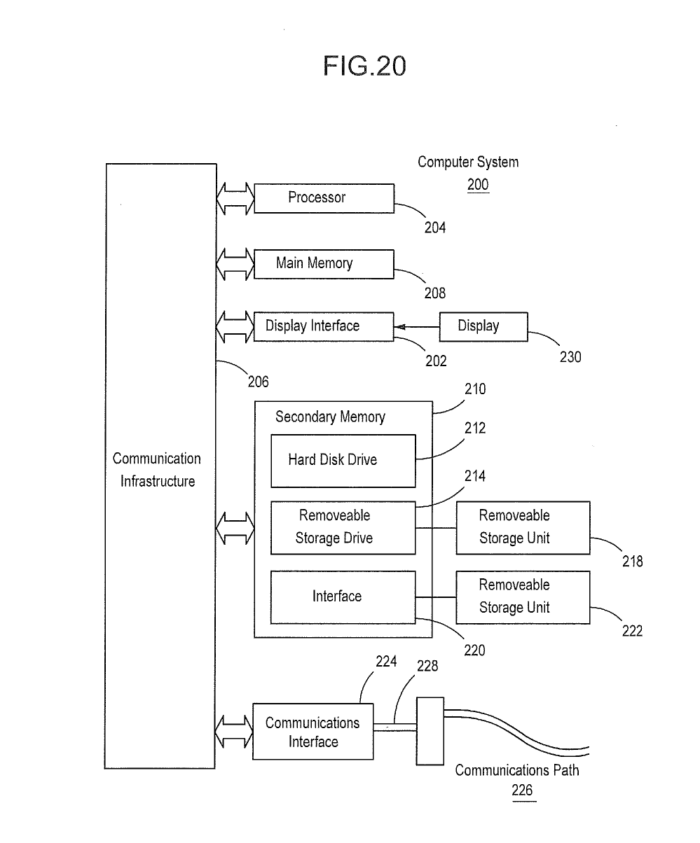

Aspects of the present invention may be implemented using hardware, software or a combination thereof and may be implemented in one or more computer systems or other processing systems. In one variation, aspects of the present invention may be directed toward one or more computer systems capable of carrying out the functionality described herein. An example of such a computer system 200 is shown in FIG. 20.

Computer system 200 includes one or more processors, such as processor 204. The processor 204 is connected to a communication infrastructure 206 (e.g., a communications bus, cross-over bar, or network). Various software features are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on a display unit 230. Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well-known manner. Removable storage unit 218, represents a floppy disk, magnetic tape, optical disk, etc., which is read by and written to removable storage drive 214. As will be appreciated, the removable storage unit 218 includes a computer usable storage medium having stored therein computer software and/or data.

In alternative variations, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred through communications interface 224 are in the form of signals 228, which may be electronic, electromagnetic, optical or other signals capable of being received by communications interface 224. These signals 228 are provided to communications interface 224 through a communications path (e.g., channel) 226. This path 226 carries signals 228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 214, a hard disk installed in hard disk drive 212, and signals 228. These computer program products provide software to the computer system 200. The invention is directed to such computer program products.

Computer programs (also referred to as computer control logic) are stored in main memory 208 and/or secondary memory 210. Computer programs may also be received through communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In variations where the invention is implemented using software, the software may be stored in a computer program product and loaded into computer system 200 using removable storage drive 214, hard drive 212, or communications interface 224. The control logic (software), when executed by the processor 204, causes the processor 204 to perform the functions of the invention as described herein. In another variation, aspects of the present invention can be implemented primarily in hardware using, for example, hardware components, such as application specific integrated circuits (ASICs). Implementation of the hardware state machine so as to perform the functions described herein will be apparent to persons skilled in the relevant art(s).

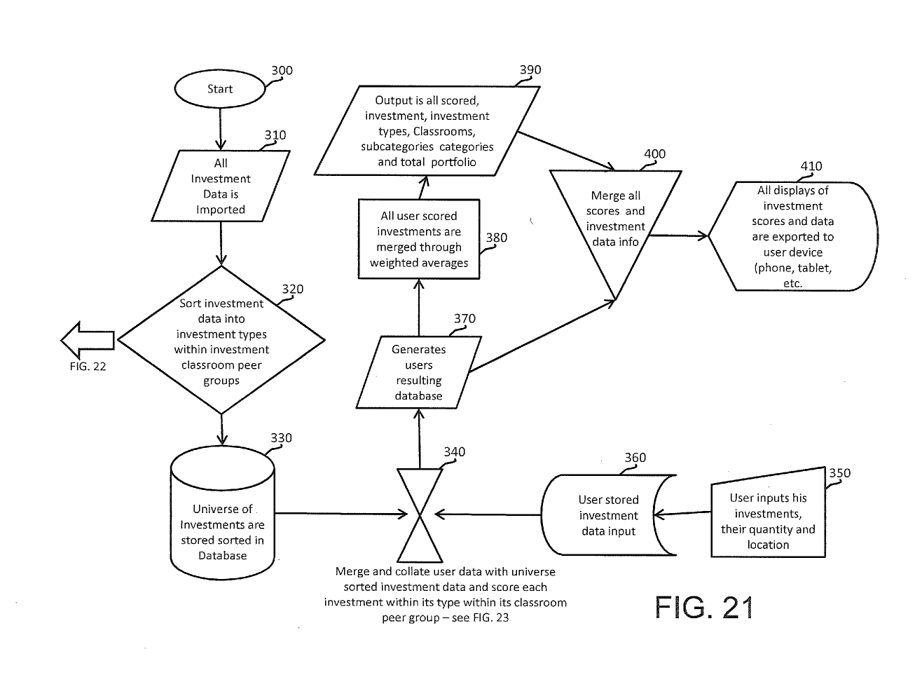

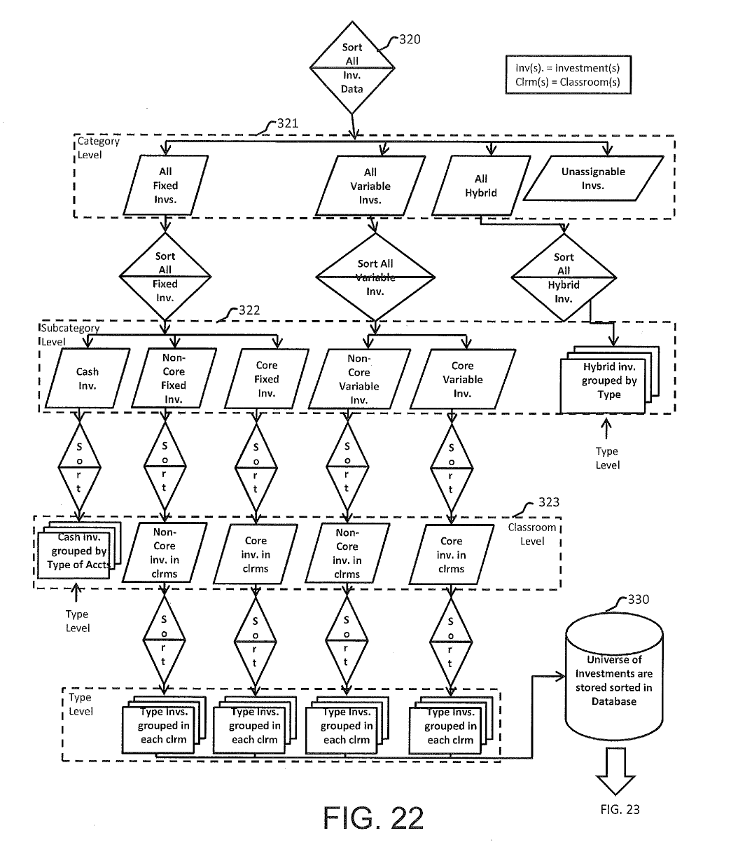

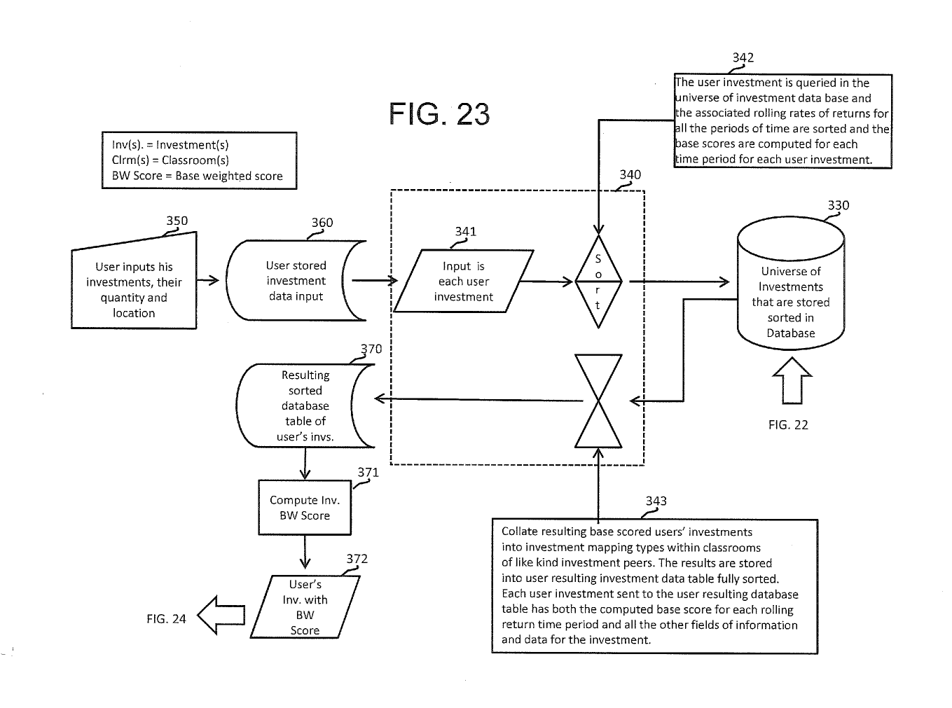

FIG. 21 is a flow diagram illustrating an exemplary method of assessing an aggregated investment portfolio in accordance with aspects of the present disclosure, requiring a computer coupled to a database of statistical financial data that is processed in accordance with a set of user inputs to derive a tiered scoring assessment of the investment portfolio. As shown in FIG. 21, the method begins at step 300, wherein a system processor, such as the processor 204 described above, may trigger a data call. All of the investment raw data of a large portion of all investments in the universe of investments both domestic and non-domestic is imported at step 310 into the universe database. At step 320, the processor kicks off the process of sorting the raw data into like kind groupings and ultimately down into investment types within the like kind peer group investment classrooms, as described previously. FIG. 22 illustrates the detailed steps involved in processing and sorting the imported raw data. The raw data is first sorted into categories at step 321. For example, the raw data may be sorted into the following four categories:
a. fixed investments;
b. variable investments;
c. hybrid investments; and
d. unassignable investments which are not scored.

The categorized data is further processed and sorted into subcategories at step 322. For example, the categorized data may be sorted into subcategories as follows:
a. the fixed investment category is sorted into three sub categories of cash investments, non-core fixed investments and core fixed investments;
b. the variable investment category is sorted into two sub categories of non-core variable investments and core variable investments; and
c. the hybrid investments are sorted into hybrid investment types.

Within each subcategory the data may be further processed and sorted at step 323 as follows:
a. The fixed investment side may be further sorted as follows:
   i. Cash investments may be sorted into types of account (checking, money market, savings etc.);
   ii. Non-Core fixed investments may be sorted into classrooms of like kind peer investments; and
   iii. Core fixed investments may be sorted into classrooms of like kind peer investments.
b. The variable investment side may be further sorted as follows:
   i. Non-Core variable investments may be sorted into classrooms of like kind peer investments; and
   ii. Core variable investments may be sorted into classrooms of like kind peer investments.

At the most granular type level, the data may be further processed and sorted at step 324 as follows:
a. The fixed investment side may be further sorted as follows:
   i. Non-Core fixed investments' classrooms of like kind peer investments are sorted into the respective investment type within each classroom; and
   ii. Core fixed investments' classrooms of like kind peer investments are sorted into the respective investment type within each classroom.
b. The variable investment side may be further sorted as follows:
   i. Non-Core variable investments' classrooms of like kind peer investments are sorted into the respective investment type within each classroom.
   ii. Core variable investments' classrooms of like kind peer investments are sorted into the respective investment type within each classroom.

At this point the entire universe of investment raw data that has been imported into the system is fully sorted into investment types within each respective classroom of like kind peer of investments. As indicated at step 330 in FIGS. 21 and 22, the sorted data may be stored in a Universe Database for further queries and computations by the system to derive meaning to user's individual investments within their respective portfolios. Each investment is now sorted and stored in the universal database and carries with it the respective attributes and any imported information associated with the investment that will form part of the queries and computations used by the system.

Referring back to FIG. 21, with the raw data sorted and stored in the universe database at step 330 as indicated above, the user's specific data associated with the user's investment portfolio is merged and collated at step 340 with the universe sorted investment data so that each investment in the user's portfolio can be allocated the base score within its type within its classroom peer group.

As shown at step 350, the user enters each investment within their portfolio of investments by entering the investments symbol, number of shares of investment (may be other quantity unit depending on investment class) and location of the investment. As noted previously, in accordance with aspects of the present invention, a financial data delivery module may be used to automatically retrieve and/or distribute the user's relevant financial data or the user may manually enter the data as needed. As shown at step 360, all of the users inputted investments may be stored in a user input database. The user can access the database through their mobile device, for example, to update their investments, input information, delete the investment or add additional investments at any time or could be done automatically through the previously described financial data delivery module.

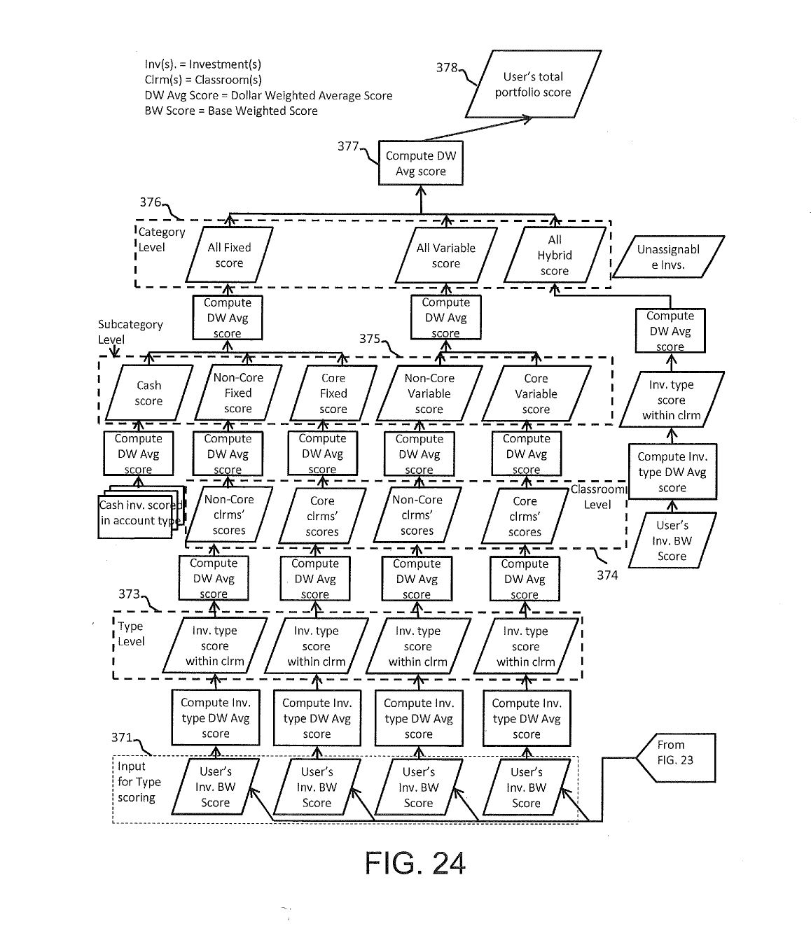

The scoring of user input investments at step 340 may be further illustrated with reference to FIG. 23. As described above, at step 350 the user may enter each investment within their portfolio of investments and all of the users inputted investments may be stored in a user input database at step 360. The user can access the database through their mobile device, for example, to update their investments, input information, delete the investment or add additional investments at any time. At step 341, each user stored investment may then be processed and at step 342 queried against the matching investment stored in the universe database. Once the investment is found in the universe database it is compared to all of its peer investments within the same type of investment within its classroom of peer investments. This comparison involves comparing the associated rolling rates of returns for all the periods of time and computing each base score for each defined investment holding time period of the total rolling rate of return time period (TRRR).

As discussed previously, the base score is determined by having the system sort the investments within the investment type in sequential order from highest TRRR to lowest TRRR. The investment in the investment type with the highest TRRR value within a defined time period is set to 100 and the investment in the same investment type with the lowest TRRR is set to 1. All other investments within the investment type are then ranked by their proportional percentage values between the highest and lowest TRRR, resulting in a percentage ranking for each investment within said investment type within the classroom of the investment peer group. The ranking is the base score. The processor derives a base score for each defined TRRR time period for all the TRRR being tracked.

The aggregated base scores for each defined TRRR time period are then assigned to each user's investment. For each user's investment, the system, via the processor, may also acquire from its associated queried investment found in the Universe Database all of the investment's data points that were brought into the Universe Database and assigned to the investment. The user's investment with its base scores and associated data points are then collated and stored in a User Resulting Database at step 370. Each user's investment is collated within its type of investment within classroom of like kind peers of user's investments in the same sort order found within the Universe Database.

The investment stored in the User Results Database may then be processed at step 371 to compute the Base Weighted Score for that user investment. As described previously, the weighting values are either a default or user defined weighting values of the various TRRR time period Base Scores. For example there may be heavier weighting applied to the shorter TRRR time period Base Scores then the longer term TRRR time period Base Scores. The weighting is arithmetically applied to each Base Score for the investment through a weighting algorithm to result in a single score for the investment. This single score is the Base Weighted Score for the user's investment. As indicated at step 372, the Base Weighted Score for each user investment is the input element for each investment type in each classroom, as described in detail in FIG. 24. The Base Weighted Score is the most basic element which starts the Dollar Weighted Averages Scoring computations.

FIG. 24 illustrates the system's ability to compute user investment, classroom, category and total portfolio scores. As described above with respect to FIG. 23, each user's investment had Base Scores computed for each of the TRRR time periods. These Base Scores were then combined through a weighting algorithm using either the default weighting values or user defined weighting values to derive the Base Weighted Score for each investment, as shown in step 371 of FIG. 24. At step 373, the Dollar Weighted Average Scoring of each investment type within a classroom is computed. The Base Weighted Score of each investment within their respective type within a given classroom is combined through a weighting computational algorithm with the associated dollar value of the investment to arrive at one score called the Dollar Weighted Average Score for the investment type. This Dollar Weighted Average Score for the given investment type is derived from the computation of the sum of the products of multiplying each investment Base Weighted Score value by the present dollar value of each investment. The resulting sum of each of the products for each of the investment is then divided by the sum of the total dollar value of the investments within the same investment type. The final result of this computation is the Dollar Weighted Average Score for the investment type.

At step 374, the Dollar Weighted Average Scoring of each classroom within a sub-category is computed. The Dollar Weighted Average Score of each investment type within a given classroom is combined through a weighting computation algorithm with the associated dollar value of the investment type to arrive at one score called the Dollar Weighted Average Score for the classroom. This Dollar Weighted Average Score for the given classroom is derived from the computation of the product of multiplying each investment type Dollar Weighted Average Score value to the dollar value of each investment type grouping in the classroom. The resulting sum of those products is then divided by the sum of the total dollar value of the investment type groupings in the classroom. The final result of this computation is the Dollar Weighted Average Score for the classroom.

At step 375 the Dollar Weighted Average Scoring is derived for each sub-category within a category. The Dollar Weighted Average Score of each classroom within a given sub-category is combined through a weighting computation algorithm with the associated dollar value of the classroom to arrive at one score called the Dollar Weighted Average Score for the subcategory. This Dollar Weighted Average Score for the given subcategory is derived from the computation of the sum of the products of multiplying each classroom Dollar Weighted Average Score value by the dollar value of each classroom. The resulting sum of those products for every classroom in a subcategory is then divided by the sum of the total dollar value of the classroom. The final result of this computation is the Dollar Weighted Average Score for the subcategory.

At step 376, the Dollar Weighted Average Scoring of category within a total portfolio is computed. The Dollar Weighted Average Score of each subcategory within a given category is combined through a weighting computation algorithm with the associated dollar value of the subcategory to arrive at one score called the Dollar Weighted Average Score for the category. This Dollar Weighted Average Score for the given category is derived from the computation of the sum of the products of multiplying each subcategory Dollar Weighted Average Score value by the dollar value of each subcategory. The resulting sum of those products for every subcategory is then divided by the sum of the total dollar value of the subcategories. The final result of this computation is the Dollar Weighted Average Score for the category.

The Dollar Weighted Average Score of each category within the portfolio may then be combined through a weighting computation algorithm with the associated dollar value of the category to arrive at one score called the Dollar Weighted Average Score for the portfolio, as indicated at step 377. This Dollar Weighted Average Score for the given portfolio is derived from the computation of the sum of the products of multiplying each category Dollar Weighted Average Score value by the dollar value of each category. The resulting sum of those products for every category is then divided by the sum of the total dollar value of the category. The final result of this computation is the Dollar Weighted Average Score for the portfolio.

FIG. 24 illustrates that the resulting Dollar Weighted Average Score keeps combining at each level in accordance with a predetermined weighted algorithm such that a Dollar Weighted Average Score is derived beginning with each investment, continuing with the investment type level, classroom level, the sub-category level, the category level and then finally deriving an overall user's portfolio score. The total portfolio score and each score of each category, sub-category, classroom, type and ultimately the investment itself brings comparative meaning and performance feedback by easily informing the user of his percentage rank of his investment dollars within each of his investments and the investments combined peer classes and groupings. In accordance with yet other aspects of the present invention, a historical record of base scores and all associated scores for each grouping may be maintained by the system for an investor to be able to aggregate over time the performance of any single investment, group of investments, and/or the entire portfolio based on any period of time indicated by the investor.

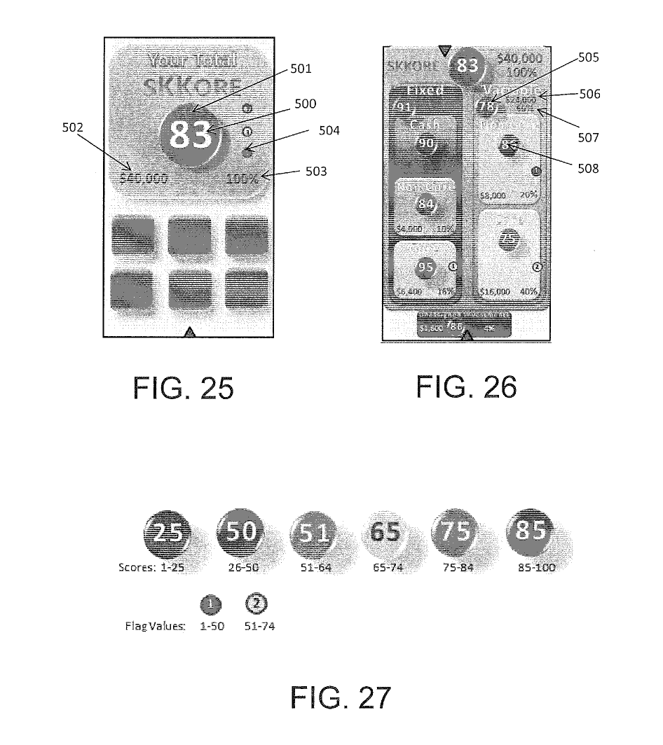

Referring back to FIG. 21, the output of the algorithmic derivations computed by the system in accordance with the methods outlined above is merged at step 400 and then compiled by the processor into an electronically displayable file for export at step 410 to the user's device, such as a phone, tablet, etc. FIGS. 25-31 illustrate yet other aspects of the present disclosure in which the electronically displayable files may be configured to present the sKKore derived scores. For example, as shown in FIG. 25, the total portfolio score 500 (i.e., the sKKore) could be displayed as a large button icon 501 with the sKKore displayed therein. Other information may be provided on the home page such as the total portfolio value 502 and the percentage value 503 of the portfolio comprising the sKKore. As is explained below, flags 504 may be set that are displayed on the home page to illustrate quickly and easily to the user potential issues in their portfolio requiring further inquiry.

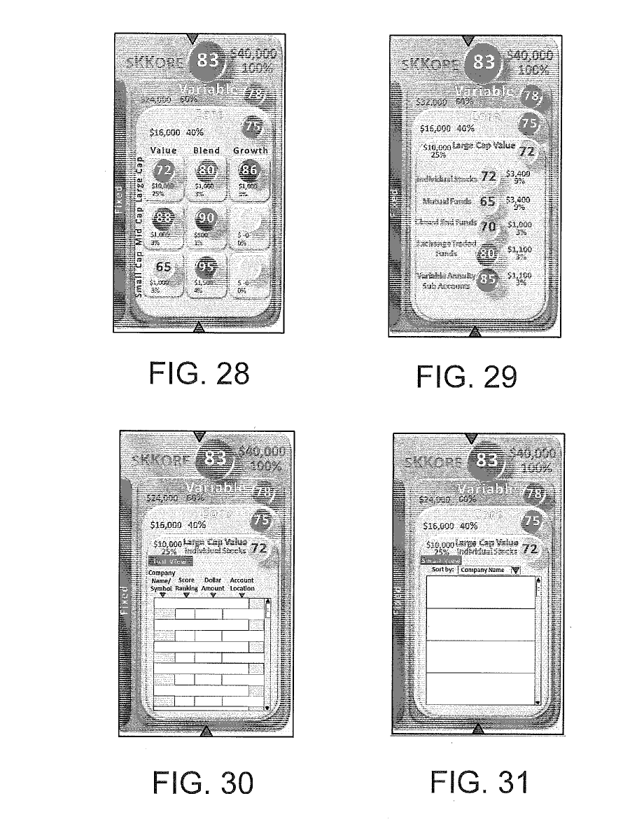

The information may be presented to the user in an indexed, hierarchical structure, wherein the user may easily and intuitively navigate to more detailed levels of information. For example, selecting the portfolio score 500 may bring up the page shown in FIG. 26, wherein the scores for the next level down (i.e., the category level) may be displayed. As illustrated in the figure, the category scores 505 for each category along with the category dollar value 506 and category percentage value 507 may be displayed. Each sub-category score 508 may be shown along with dollar value and percentage value for the sub-category. As shown in FIGS. 28-31, the user may be presented with many ways to have the scoring information at their fingertips, including side swipe menus to easily navigate between categories and/or scroll tables that allow for the investor to scroll through their individual investments in any investment type within a sub-category within a category.

FIG. 27 illustrates how various tools may be configured into the system to quickly provide status information to the user. Visual cues such as color coding of the score symbols may be used to provide immediate verification of a particular score range. Flags 504 may be set by the user to indicate when the score of a particular investment, investment type, classroom, sub-category, or category hits a particular predetermined threshold. For example, a small yellow flag may be used to indicate that an investment has a score of between 51-74 while a red flag indicates a lower score yet of between 1-50.

It is to be understood that any feature described in relation to any one aspect may be used alone, or in combination with other features described, and may also be used in combination with one or more features of any other of the disclosed aspects, or any combination of any other of the disclosed aspects.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may fall within the scope of the invention.

What is claimed is:

1. A method of real time assessment of an aggregated investment portfolio requiring a computer coupled to a database of statistical financial data, wherein a processor integrated with the computer receives instructions to perform the method, the method comprising:
querying the database and retrieving a set of data points associated with a plurality of investments;
controlling the processor to sort like-kind investments of the plurality of investments into an investment type and storing the plurality of investments in a system database;
receiving via an electronic user interface data associated with at least one user investment;
querying the system database via the processor to match each of the at least one user investment with the set of data for one of the plurality of investments;
deriving an investment score for each of the at least one user investment using the processor to compare and rank the set of data points for each user investment against all the sets of data points for the plurality of other like-kind investments;
processing a weighted base score for each user investment via the processor and using a weighting algorithm applied against the set of data points for each user investment to adjust the investment score;
via the processor, multiplying the weighted base score of each user investment by the present dollar value of the investment to derive a dollar weighted value for each user investment; and
deriving a dollar weighted average score for the investment type by summing each dollar weighted value for each user investment and dividing the sum by a total dollar value of all of the user investments comprising the investment type; and
displaying the dollar weighted average score to the user through the electronic user interface.

2. The method of claim 1, wherein the processor further categorizes a plurality of investment types into a classroom group and the user investment is associated with the classroom group and stored in the system database.

3. The method of claim 2, wherein the processor further categorizes a plurality of classroom groups into a subcategory and the user investment is associated with the subcategory and stored in the system database.

4. The method of claim 3, wherein the processor further categorizes a plurality of subcategories into a category and the user investment is associated with the category and stored in the system database.

5. The method of claim 1, wherein the weighted algorithm applied by the processor to the user investment within the investment type is determined by user input through the electronic user interface.

6. The method of claim 1, wherein the data points include rolling rates of returns for all periods of time included in a total rolling rate of return time period.

7. The method of claim 4, further comprising:
computing via the processor a classroom dollar weighted average score for each classroom by deriving at least one investment type product through multiplying each investment type dollar weighted average score with a dollar value of each investment type in the classroom, summing the investment type products and dividing the sum by a total dollar value of all investment types in the classroom; and
displaying the classroom dollar weighted average score to the user through the electronic user interface.

8. The method of claim 7, further comprising computing via the processor a sub-category dollar weighted average score for each sub-category by deriving at least one classroom product through multiplying each classroom dollar weighted average score with a dollar value of each classroom in the sub-category, summing the classroom products and dividing the sum by a total dollar value of all classrooms in the sub-category; and
displaying the sub-category dollar weighted average score to the user through the electronic user interface.

9. The method of claim 8, further comprising:
computing via the processor a category dollar weighted average score for each category by deriving at least one sub-category product through multiplying each sub-category dollar weighted average score with a dollar value of each sub-category in the category, summing the sub-category products and dividing the sum by a total dollar value of all sub-categories in the category; and
displaying the category dollar weighted average score to the user through the electronic user interface.

10. The method of claim 9, further comprising:
computing via the processor a portfolio score by deriving at least one category product through multiplying each category dollar weighted average score with a dollar value of each category in the portfolio, summing the category products and dividing the sum by a total dollar value of all categories in the portfolio; and
displaying the portfolio score to the user through the electronic user interface.

11. The method of claim 1, further comprising:
flagging the user investment when the investment score reaches a predetermined threshold score; and
displaying a visual indicator of the flagged user investment on the electronic user interface.

12. The method of claim 11, wherein upon receipt of a specific user input, the processor activates a trade and replace of the user investment that reached the predetermined threshold.

13. The method of claim 1, further comprising:
providing linked access to a secondary user to view the investment score.

14. A system for real time assessment of an aggregated investment portfolio, the system comprising:
a computer comprising a processor for executing instructions stored in a memory device;
a database of statistical financial data capable of being accessed by the computer;
a system database; and
an electronic user interface for receiving inputs from an investor, wherein the processor receives instructions to:
query the database and retrieve a set of data points associated with a plurality of investments;
sort like-kind investments of the plurality of investments into an investment type and storing the plurality of investments in a system database;
receive via the electronic user interface data associated with at least one user investment;
query the system database via to match each of the at least one user investment with the set of data for one of the plurality of investments;
derive an investment score for each of the at least one user investment using the processor to compare and rank the set of data points for each user investment against all the sets of data points for the plurality of other like-kind investments;
process a weighted base score for each user investment and use a weighting algorithm applied against the set of data points for each user investment to adjust the investment score;
multiply the weighted base score of each user investment by the present dollar value of the investment to derive a dollar weighted value for each user investment; and
derive a dollar weighted average score for the investment type by summing each of the dollar weighted value for each user investment and dividing the sum by a total dollar value of all of the user investments comprising the investment type; and
display the dollar weighted average score to the investor through the electronic user interface
